(19) United States
(12) Patent Application Publication
(10) Pub. No.: US 2011/0063701 A1
(43) Pub. Date: Mar. 17, 2011

(54) Digital optical, planar holography system and method for improving brightness of light beams

(75) Inventor: Vladimir Yankov, Washington Township, NJ (US)

(73) Assignee: Nano-optic Device, LLC

(21) Appl. No.: 12/584,891

(22) Filed: Sep. 14, 2009

(51) Int. Cl. G02B 27/10; G02B 5/32

(52) U.S. Cl. 359/15

(57) ABSTRACT

The proposed laser-beam system is a compact device of a hybrid or monolithic type, which is based on the use of digital planar holography (DPH) and is capable of coherently combining laser beams emitted from various laser sources. The hybrid DPH beam combiner is fabricated on a separate substrate and is optically coupled with a laser array, while the monolithic combiner is embedded into the laser array planar waveguide. In both configurations, the DPH combiner performs coherent combining and thus preserves a single transverse mode in combined laser beams at a common wavelength.

### FIELD OF THE INVENTION

The present invention generally relates to lasers and specifically to a method for combining numerous laser beams with preserved or improved beam quality for power and brightness scaling. The invention also relates to an optical planar system based on planar holography and to a method of improving brightness of light beams with the use of the digital optical planar holography system.

### BACKGROUND INFORMATION

Many attempts have been made to combine laser beams by means of various devices and methods. For example, U.S. Pat. No. 4,246,548, granted to E. M. Rutz in 1981, describes a coherent laser array with an external resonator comprising spherical lenses, plane mirrors, and a spatial filter for transverse mode selection.

J. R. Leger, et al, in U.S. Pat. Nos. 4,813,762 issued in 1989 and 5,033,060 issued in 1991 proposed a coherent beam combining with an array of phase correctors and Talbot imaging. All components are placed into an external resonator.

Edwards, et al, in U.S. Pat. No. 5,029,964 issued in 1991 disclosed a laser-beam combiner for a plurality of high-power lasers, including a holder arrangement to receive the ends of the optical fibers, three collimating lenses, and a single focusing lens. The ends of the three optical fibers are located substantially on a common plane and are circularly spaced at 120-degree intervals. The three collimating lenses are also located substantially on a common plane, and their axes are circularly spaced at 120-degree intervals. Each of the collimating lenses is aligned with one of the optical fibers. The laser beams are directed by the collimating lenses, as collimated beams, onto the focusing lens with the axes of the individual beams parallel to each other.

Horikawa, et al, in U.S. Pat. No. 5,216,544 issued in 1993 proposed a beam-combining device comprising an airtight housing and a laser-beam source unit housed in the housing. The laser-beam source unit comprises laser-beam sources and collimator optical systems respectively positioned in optical paths of laser beams, which are radiated from the laser beam sources in order to collimate the laser beams. Optical-path adjusting elements are respectively positioned in the optical paths of the laser beams in order to radiate the laser beams along optical paths that are parallel and close to one another. The laser-beam sources, the collimator optical systems, and the optical-path adjusting elements are supported on a single support.

Veldkamp, et al, in U.S. Pat. No. 4,649,351 issued in 1987 disclosed an apparatus and method for coherently adding laser beams, including a diffraction grating illuminated by a plurality of lasers. The laser beams are combined coherently by phase locking and diffracting the beams into a single beam. The diffraction grating is configured to generate, upon illumination, substantially equal intensities of diffraction orders corresponding to the number of lasers while suppressing higher unwanted orders.

L. B. Glebov in his publication, “High brightness laser design based on volume Bragg gratings” in Proc. SPIE Vol. 6216 (2006), developed the idea of combining laser beams with thick (volume) Bragg gratings fabricated on photo-thermal-refractive glass plates by exposing them to ultraviolet laser radiation.

Rothenberg, et al, in U.S. Patent Application 20080084605 published in 2008 describes a hybrid beam-combining system and method for combining a plurality of coherent and incoherent light beams into a composite high-power diffraction-limited beam. Each N oscillator transmits light at one of N different wavelengths, and each wavelength is split into M constituent beams. M beams in each of the N groups are phase-locked by a phase modulator using phase-correction signals. The phase-locked beams are amplified and coupled into an M×N fiber array. Beams emerging from the array are collimated and incident on a diffractive optical element operating as a beam combiner to combine M outputs at each N wavelength into a single beam. The N single beams are incident and spectrally combined on a grating that transmits a composite beam at a nominal 100% fill factor. A low-power sample beam, taken from the N beams emerging from the diffractive optical element, is measured for phase deviations from which the phase-correction signals are derived and fed back to the phase modulators. The diffractive optical element may include a weak periodic grating for diffracting the low-power sample. The diffractive optical element may also be combined with the spectral combining grating into a single optical element.

Rothenberg, et al, in U.S. Patent Application 20080084598 published in 2008 discloses a method and system for coherent beam combining using an integrated diffractive beam combiner and sampler, which combines plural low-power light beams into a coherent high-power light beam by means of a diffractive optical element operating as both a beam combiner and beam sampler. An oscillation source transmits a master signal that is split into plural beams propagating at a common wavelength. Each beam is phase-locked by a corresponding phase modulator according to a phase-correction signal. The beams are directed through a fiber array to the diffractive optical element to allow efficient coherent combination of the beams at a desired diffraction order. The diffractive optical element includes a periodic-sampling grating for diffracting a low-power sample beam representative of the combined beam. A phase-detection stage detects phases of constituent beams in the sample beam from which the phase-correction signals are derived and fed back to the phase modulators. The diffractive optical element may be further modified to collimate beams diverging from the fiber array and to focus the sample beam onto a phase detector.

Donoghue, et al, in U.S. Patent Application 20020181035 published in 2002 proposed a method and system for combining multiple low-power laser sources to achieve high-efficiency, high-power output using holographic transmission methodologies. A holographic beam combiner (HBC) is used to combine output from many lasers into a single-aperture, diffraction-limited beam. The HBC is based on the storage of multiple holographic gratings in the same spatial location. By using a photopolymer material such as quinone-doped polymethylmethacrylate (PMMA) that uses the novel principle of “polymer with diffusion amplification” (PDA), it is possible to combine a large number (N) of diode lasers with an output intensity and brightness 0.9 N times as much as those of combined outputs of individual N lasers. The HBC is a small, inexpensive-to-manufacture, and lightweight optical element. The basic idea of the HBC is to construct multiple holograms onto a recording material, with each hologram using a reference-beam incident at a different angle but keeping the object beam at a fixed position. When illuminated by a single read beam at an angle matching one of the reference beams, a diffracted beam is produced in the fixed direction of the object beam. When multiple read beams that match multiple reference beams are used simultaneously, all beams can be made to diffract in the same direction and under certain conditions that depend on the degree of mutual coherence between input beams.

Miller in U.S. Pat. No. 7,265,896 published in 2007 described laser-beam combining for nonlinear frequency conversion with nonlinear feedback to the sources being combined. Such nonlinear feedback can advantageously reduce output-power sensitivity from the wavelength conversion device to variations in the nonlinear coefficients of the conversion device. The reason for this reduced sensitivity is that in preferred embodiments, feedback power increases if a nonlinear coefficient decreases and tends to increase the power supplied to the conversion device, thus mitigating the effect of the reduced nonlinear coefficient.

Miller in U.S. Pat. No. 7,423,802 issued in 2008 disclosed a multicolor illumination module providing light in a plurality of colors, including Red-Green-Blue (RGB) light and/or white light. In one embodiment the illumination module includes a laser configured to produce an optical beam at a first wavelength, a planar lightwave circuit coupled to the laser and configured to guide the optical beam, and a waveguide optical-frequency converter coupled to the planar lightwave circuit and configured to receive the optical beam at the first wavelength, to convert the optical beam at the first wavelength into an output optical beam at a second wavelength, and possibly to provide optically coupled feedback, which is nonlinearly dependent on the power of the optical beam at the laser first wavelength.

In U.S. Pat. No. 7,394,953 issued in 2008, Nagarajan, et al, proposed configurable optical combiners and decombiners to be implemented as arrayed waveguide grating-based multiplexors and demultiplexors.

Welch, et al, in U.S. Pat. No. 7,340,122, issued in 2008 described a similar monolithic integrated circuit in which the arrayed waveguide grating multiplexor is implemented on the same chip as laser sources and their modulators.

Peters, et al, in U.S. Pat. No. 7,444,048 issued in 2008 described arrayed waveguide gratings that are deployed for beam combining as well. In addition, in one embodiment, elliptical Bragg gratings are proposed for beam combining.

Although arrayed waveguide gratings solve the problem of combining laser beams inside integrated optics without using free-space optical components, they still are large and inherently complex structures that typically cover several square centimeters in area and comprise multiple waveguides. Arrayed waveguide gratings are also very sensitive to any phase error, particularly at the end of the arrayed waveguides; therefore very careful and rigorous design is critical for correct operation. Prototyping is prohibitively expensive, both in terms of cost and time; hence, modeling tools are required to provide detailed analysis of the arrayed waveguide grating operation. However, due to component size, only approximate semi-analytical methods that do not fully characterize structure and performance are available. Also, arrayed waveguide gratings do not support fabrication defects or structure degradation; any defect in one of the array arms, for example, will result in dropping the corresponding laser beam from the combined output.

Bragg gratings, proposed in U.S. Pat. No. 7,444,048 by Peters, et al, are more robust than arrayed waveguide gratings because local defects are not fatal and do not drastically degrade general performance and because the Bragg grating works as a digital hologram, wherein even a fraction of total structure performs the same functions with lower throughput. However, in this patent, N Bragg gratings, required for combining N laser beams, are placed sequentially on a planar with grating #1 being the closest to a laser diode array and grating #N being the farthest. This configuration is not optimal for phase synchronization, system miniaturization, loss minimization, and scaling in the number of combined laser beams and can be significantly improved by overlaying the gratings, as explained below.

Therefore, there is a need for a miniature beam combiner to be implemented as a component of integrated optic circuits.

### SUMMARY OF THE INVENTION

It is an object of the present invention to provide a miniature optical monolithic or hybrid beam combiner, without free-space components, that can be fabricated on a wafer by standard mass-production methods and that comprises a compact chip-level optical device.

Another object of the present invention is to provide a compact integrated optical device for the combining of laser beams for improved laser brightness.

A further object is to provide a compact optical chip that, based on digital planar holography (DPH), improves the brightness of an output beam by enhancing coherence and fusion of light beams emitted from laser diodes arranged into an array.

Another object of the invention is to provide an optical chip that incorporates a beam combiner based on the principle of DPH.

The invention provides a method and an optical device for combining laser beams on the principle of DPH. The method and apparatus of the invention improve brightness of an output beam by enhancing coherence and fusion of light beams emitted from laser diodes arranged in an array. Improvement is achieved due to correlating phases of individual light beams. The invention applies to optical chips of a hybrid or monolithic configuration; the former can be realized by fabricating a DPH beam combiner on a separate chip, which is optically coupled to a laser diode array, while the latter presumes embedding the beam combiner into the same planar optical waveguide wherein the laser array is located. DPH is a flexible technology that is suitable for planar waveguides made of various materials and for this reason applies to virtually any diode laser array. DPH optical components, including beam combiners, are digital holograms generated in a computer and manufactured by standard mass-production methods, such as binary microlithography or nanoimprinting.

Every DPH component has a complicated hierarchical structure, which can be considered as a supergrating that comprises multiple overlaid subgratings, each of which consists of standard binary features (for example, etched grooves of a rectangular configuration) formed in a planar waveguide in order to modulate its effective refractive index. Specific dimensions that are shorter than predetermined wavelengths emitted by lasers define each binary feature.

A light beam that is confined inside the planar waveguide is forced to propagate through and interacts with the DPH structure. The DPH structure is made so that it correlates phases and fusion of beams emitted from a plurality of laser diodes of an array, which results in improved brightness of the output beam emitted from the optical chip. Light propagation along the DPH structure allows the length of interaction to be as long as needed so that multiple functions can be implemented in a single hologram.

Each subgrating is a group of DPH features that constitutes a part of the supergrating and interacts with a selected laser diode, or laser diodes, to accomplish a predetermined function. In other words, each subgrating functionally acts as coherent connector of individual lasers, is part of the supergrating, and interacts with a selected laser diode, or laser diodes, to accomplish a predetermined function.

It has been shown in the description of the prior art that there are two types of combiners:
(1) Coherent beam combiners
(2) Incoherent beam combiners, which are also called wavelength combiners

The invention relates only to a coherent DPH beam combiner. The coherent DPH beam combiner of the invention is placed in a common resonator for all diode lasers. Therefore, the coherent beam combiner participates in light generation and provides beam coupling, phase correlation, and beam fusion for all lasers by partial reflection of each beam into all diode lasers of the array. This leads to light generation in all laser diodes at the same wavelength and with the same output phase so that the coherently combined beam has the same quality as that of any laser diode in the array, while brightness of the beam is scaled proportionally to the number of lasers in the array.

### BRIEF DESCRIPTION OF THE DRAWINGS

FIG. 1A is a block diagram that shows the structure of a conventional multibeam optical system that comprises an optical waveguide and an output optical unit that manages an output beam emitted from the waveguide.

FIG. 1B is a block diagram that shows a multibeam optical system according to one aspect of the invention wherein the DPH beam combiner is used in place of the full-reflection mirror.

FIG. 1C is a block diagram that shows a multibeam optical system according to another aspect of the invention wherein the DPH beam combiner is used in place of the partially reflecting mirror.

FIG. 1D is a block diagram that shows a multibeam optical system according to another aspect of the invention wherein the DPH beam combiner works in combination with a partially transparent mirror that belongs to the laser array.

FIGS. 2A to 2F are schematic views that show coupling and interaction of various laser diodes with various subgratings of the optical chip of the invention.

FIG. 2G is a general schematic view of the optical chip that illustrates the laser array and the DPH beam combiner (some components are omitted for simplicity of explanation).

FIG. 3 is a view of a beam-combining system of the invention wherein a DPH beam combiner, itself, works as a full-reflection mirror.

FIG. 4A is a view that shows a beam-combining system of the invention wherein the DPH beam combiner intercouples all laser diodes and functions as a partially reflecting mirror while one mirror of the system is a full-reflection component of the resonator.

FIG. 4B shows a beam-combining system of the invention wherein the DPH beam combiner intercouples all laser diodes and functions as an addition to a partially reflecting mirror while another mirror is used as a full-reflection mirror.

FIG. 5 is a modification of the beam-combining system of the invention, wherein laser diodes have a common full-reflection mirror on their back facets and wherein the DPH beam combiner reflects a part of laser radiation at some angle to the beams that interact with the full-reflection mirror.

FIG. 6A shows a modification to the beam-combining system of the invention which is similar to the system shown in FIG. 4A but uses a single laser that has a wide active area and a broad multimode output beam.

FIG. 6B shows a modification of the beam-combining system of the invention similar to the system of FIG. 3 but using a single laser that has a wide active area and a broad multimode output beam.

FIG. 6C shows a modification to the beam-combining system of the invention which is similar to the system shown in FIG. 4B but uses a single laser that has a wide active area and a broad multimode output beam.

### DETAILED DESCRIPTION

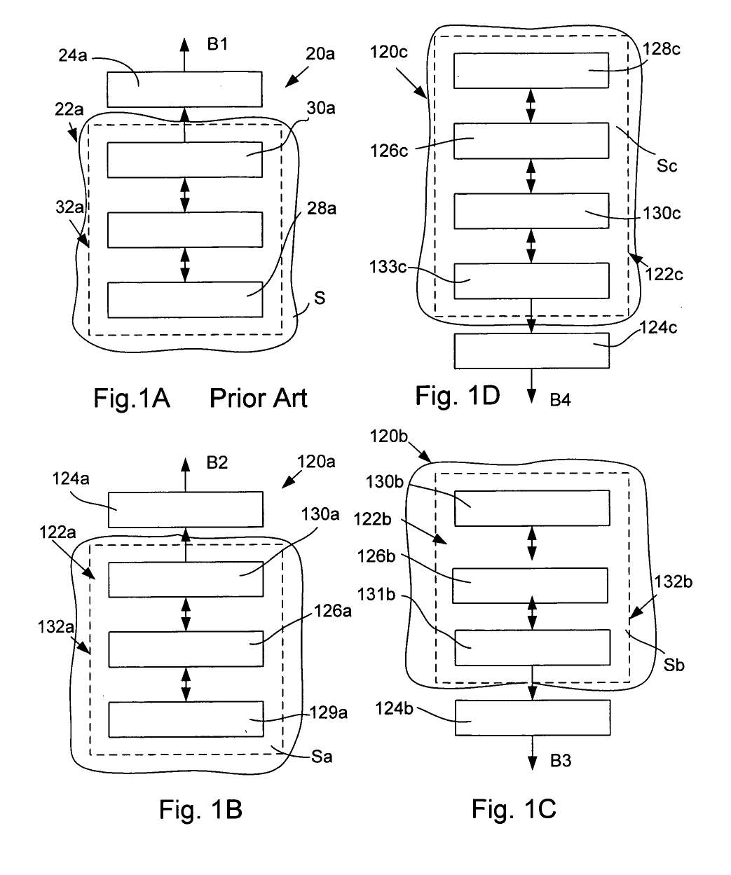

FIG. 1A is a block diagram of a conventional multibeam optical system 20a that comprises an optical waveguide 22a and an optical output unit 24a that manages an output beam B1 emitted from the waveguide 22a. The optical waveguide 22a consists of an array of single-mode laser diodes 26a, hereinafter referred to as “laser-active medium 26a” which is placed between a full-reflection mirror 28a and a partially reflecting mirror 30a. It is understood that in the structure of the optical waveguide 22a, the mirrors 28a and 30a form an optical resonator 32a. All of these parts are mounted on a substrate S. In the resonator 32a, the light applied from the laser-active medium 26a bounces back and forth between the mirrors 28a and 30a, enhancing stimulated emission. It should be noted that the beams radiated by the laser diodes of the laser-active medium 26a are incoherent. The system 20a described above and shown in FIG. 1A is a well-known structure used in laser diode technique. The inventor herein has found that in addition to light reflection, one or both mirrors 28a and/or 30a can impart to the system 20a a new function, i.e., the function of an optical beam combiner, which provides intercoupling of all laser diodes of the array 26a in order to stabilize the radiating wavelength, to synchronize phases of all beamlets, and to improve mode structure and brightness of the combined output beam B. Furthermore, according to the invention, system components used for accomplishing the aforementioned beam-combining function and other functions can be embodied as DPH optical components formed as digital planar holograms generated in a computer and manufactured by standard mass-production methods, such as binary microlithography or nanoimprinting. As a result, a beam-combining system 120a of the type shown in FIG. 1B is obtained. In the context of the present invention, the term “beam-combining system” covers an assembly comprising a laser array and a planar waveguide that contains a DPH beam combiner.

In the beam-combining system 120a, components that are similar those in the system shown in FIG. 1A are designated by the same reference numerals with the addition of 100. For example, the system 120a comprises an optical waveguide 122a and an output optical unit 124a that manages the output beam B2 emitted from the waveguide 122a. The optical waveguide 122a is coupled and interacts with an array of single-mode laser diodes 126a, hereinafter referred to as “laser-active medium 126a”. The laser-active medium is placed on the same substrates Sa on which the DPH beam combiner 129a that accomplishes the aforementioned new functions is formed (the functions of beam combining and intercoupling of all laser diodes of the array 126a in order to stabilize the radiating wavelength, synchronize phases of all beamlets, and improve the mode structure of the combined output beam B2). In other words, the laser-active medium 126a and the DPH beam combiner 129a form a single optical chip. Optical coupling and interaction between the laser-active medium 126a and the waveguide 122a is well known in the art and is beyond the scope of the present invention.

The beam-combining system 120a also incorporates a partially reflecting mirror 130a. In the structure of the optical waveguide 122a, the DPH beam combiner 129a and the mirror 130a form an optical resonator 132a. In the resonator 132a, the light applied from the laser-active medium 126a bounces back and forth between the DPH beam combiner 129a and the partially transparent mirror 130a, thereby enhancing stimulated emission. Thus, it has been shown that the DPH beam combiner 129a accomplishes the function of a full-reflection mirror.

It should be noted that in addition to the above, the DPH beam combiner 129a participates in light generation and provides phase correlation and fusion of all laser beams by partial reflection of each beam into all diode lasers of the array. In other words, the resulting radiation of the output beam acquires coherency. Thus, this leads to light generation in all laser diodes at the same wavelength and with the substantially same phase downward to the output of the system so that the coherently combined beam has the same quality as that of any laser diode in the array while brightness of the beam is scaled proportionally to the number of lasers in the array.

Alternatively, the coherent-beam system of the invention can be embodied as a beam-combining system 120b (shown in FIG. 1C). This system is, in general, the same as that shown in FIG. 1B and differs from system 120a in that a DPH beam combiner 131b is used instead of the partially reflecting mirror 130a. Other components of the system 120b, which are similar to the components of the system 120b and accomplish the same functions, are designated by the same reference numerals but are accompanied by addition of the letter “b” instead of the letter “a”. The output beam of the system is designated as B3. The symbol Sb designates a substrate.

The coherent output beams B2 and B3 are collimated or focused by respective output optics 124a and 124b.

Similar to the system of the previous modification, the DPH beam combiner 131b participates in light generation and provides phase correlation and fusion of all beams emitted from all lasers by partial reflection of each beam into all diode lasers of the array 126b. In other words, the resulting radiation of the output beam acquires coherency. This leads to light generation in all laser diodes at the same wavelength and with the same phase at the output so that the coherently combined output beam B3 has the same quality as that of any laser diode in the array while brightness of the beam is scaled proportionally to the number of lasers in the array.

In both systems 120a and 120b, every DPH beam combiner 129a and 131b, respectively, has a complicated hierarchical structure, which in approximation can be considered substantially as a supergrating consisting of standard binary features (for example, etched grooves of a rectangular shape) formed in a planar waveguide in order to modulate its effective refractive index. Each binary feature is defined by three dimensions (width, length, and depth) that are shorter than the predetermined wavelength emitted by the laser that interacts with the aforementioned grooves.

As a light beam is confined inside the planar waveguide, it is forced to propagate through and interact with the DPH structure, which results in phase correlation and fusion of the beams. Light propagation along the DPH component allows the length of interaction to be as long as needed so that multiple functions can be implemented in a single hologram.

Alternatively, the beam-combining system may be incorporated into system 120c (shown in FIG. 1D) wherein a DPH beam combiner works in combination with a partially transparent mirror 130c that belongs to the laser-active medium 126c. Other components of the system 120c that are similar to those of previously described systems are designated by the same reference numeral with the addition of letter “c”.

As mentioned above, all optical components in systems 120a, 120b, and 120c are implemented as integrated devices in the form of a planar optical chip. Optionally, there can be one planar chip for the laser active media 126a, 126b, 126c and DPH beam combiners 129a, 131b, or 123c together, or two planar chips, i.e., one for the laser media and another for the DPH beam combiners. In the second case, both chips are optically coupled with each other.

According to the present invention, each DPH beam combiner is implemented as a combination of nanogrooves embedded into a planar waveguide for periodical modulation of its refractive index. The modulating function is calculated based on specific optical-transfer functions, desirable in said combiner, and implemented by standard mass-production methods such as nanolithography or nanoimprinting. Numerous nanofeatures (e.g., in an amount of 10⁵-10⁶) can be aggregated into multiple subgratings, each of which is responsible for a specific optical-transfer function.

In fact, each subgrating need not comprise a periodic structure according to the general definition of a periodic structure. Instead, each subgrating is a group of DPH features specifically selected to accomplish a predetermined function from multiple functions of the DPH beam combiner. All subgratings are superimposed on the same planar area, forming a supergrating that performs all desired functions.

Each supergrating is generated as a mathematical superposition of elliptic, parabolic, or hyperbolic subgratings with a spatial period of an approximate one-half wavelength according to the following method. The first to be created is a two-dimensional analog-generating function A(x,y) representing a superposition of modulation profiles of the refractive index. Each modulation function corresponds to the equivalent of a subgrating. Determined in this step is a two-dimensional generating function A(x,y) that resembles an interference pattern of wavelengths emitted from multiple sources at different wavelengths. The generating function A(x,y) is a mathematical linear superposition of elliptic subgrating integration.

The next step is binarization of a two-dimensional analog-generating function A(x,y), which was produced in the previous step. Binarization is achieved by applying a threshold value and assigning 1 to all areas above the predetermined threshold and 0 to the remaining areas in order to obtain a digital two-dimensional generating function B(x,y).

Next, the complex shape islands in B(x,y) with the value of 1 are simplified for presentation as a combination of standard microlithographic or nanolithographic features (short straight lines and dashes). This is accompanied by conversion to function C(x,y).

The last step is lithographic fabrication of the calculated standard microlithographic or nanolithographic features by etching all binary features as function C(x,y) to a calculated depth on a planar waveguide.

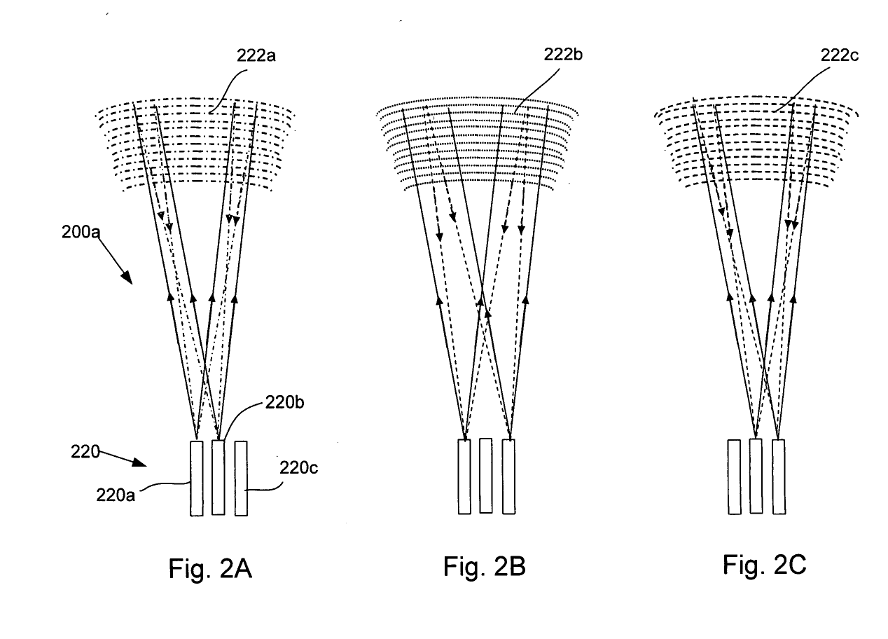

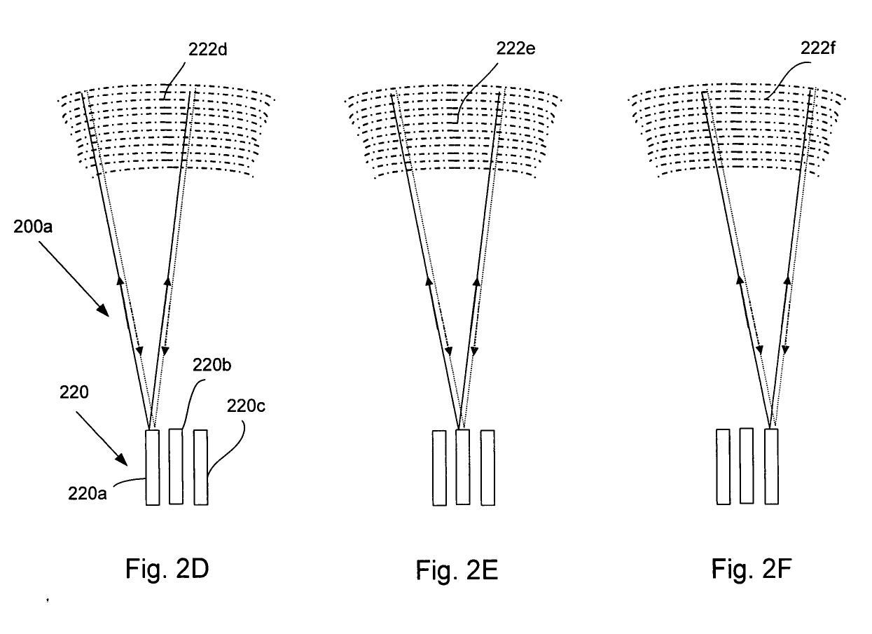

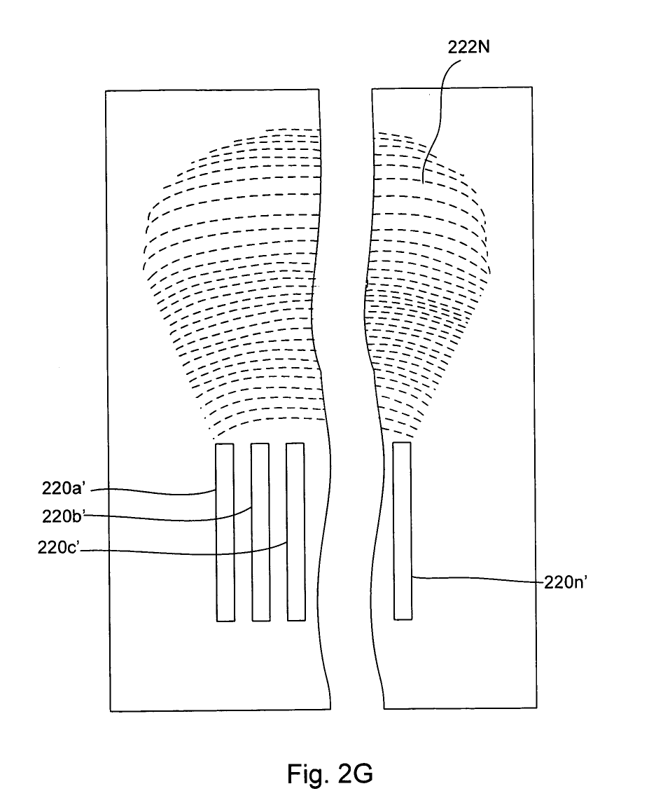

An example of the structure of a beam-combining system according to the invention is shown in FIGS. 2A to 2F. For clarity, each drawing illustrates interaction of the selected lasers with selected subgratings, which in reality are combined into a single supergrating. In other words, in each respective drawing, the illustrated system, which as a whole is designated by reference numeral 200a, consists of an array 220 of diodes 220a, 220b, and 220c and respective subgratings selected from subgratings 222a through 222f.

Light beams such as beams 224, 226, 228, and 230 shown in FIG. 2A are emitted from the respective laser diodes 220a and 220b and propagate to the subgrating 222a in a planar waveguide (not shown). For simplicity in the drawings and description, designation of the beams in FIG. 2B to FIG. 2F is omitted.

For example, in a structure that contains three laser diodes 220a, 220b, and 220c, as shown in FIGS. 2A to 2F, the following combinations can be realized:

| | | | | |
|---|---|---|---|---|
| subgrating | 222a | couples | lasers | 220a and 220b |
| | 222b | couples | | 220a and 220c |
| | 222c | couples | | 220b and 220c |
| | 222d | couples | | 220a to itself |
| | 222e | couples | | 220b to itself |
| | 222f | couples | | 220c to itself |

All subgratings are mathematically superimposed on the same planar area (not shown), forming a supergrating, where each feature works toward the best synergetic performance of all desired functions. In general, for the structure shown in FIG. 2G with supergrating 222N and N lasers 220a′, 200b′, and 220c′ through 220n′, the required number of subgratings can be calculated in the following way:
Laser 220a′ needs to be coupled with N lasers (including itself),
Laser 220b′ needs to be coupled with N−1 lasers because it has already been coupled with laser 220a′,
Laser 220c′ needs to be coupled with N−2 lasers because it has already been coupled with lasers 220a′, 220b′, and so on;
Finally, laser 220n′ needs to be coupled with itself only because it has already been coupled with all other lasers.

Therefore, the total number of subgratings m is the sum of the arithmetic progression:

m=N+(N−1)+(N−2)+ . . . +1, (1)

i.e.,

m=0.5N(N+1) (2)

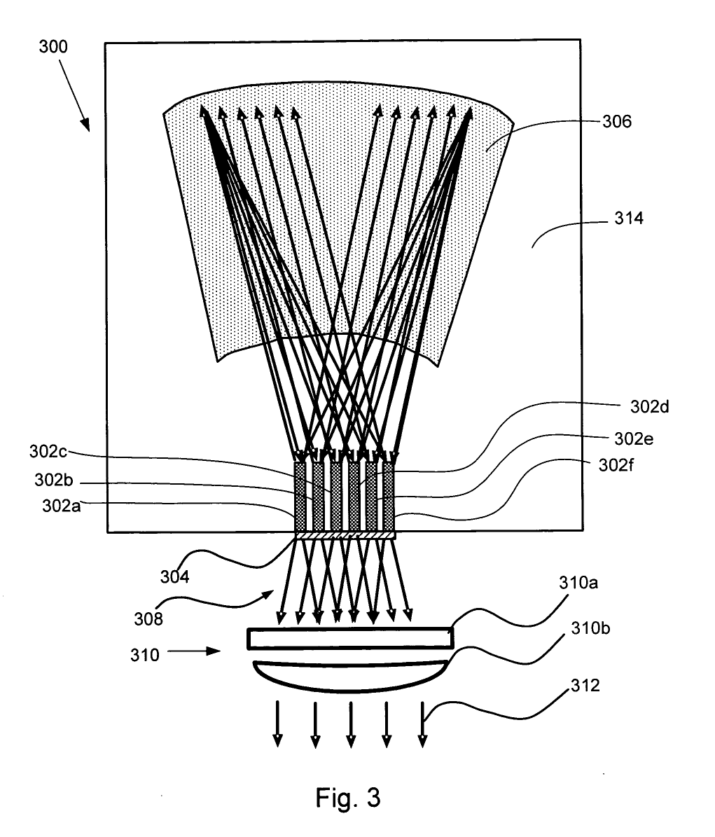

As mentioned, a DPH beam combiner can be used as a full-reflection resonator mirror or as a partial-reflection output mirror. Such modifications can be provided by varying the DPH-combiner length: short supergratings reflect only partially, reflection coefficient grows with structure length and after becoming saturated does not depend on additional increase in length, i.e., full-reflection component. These options can be better understood by considering FIGS. 3 to 5.

FIG. 3 demonstrates a beam-combining system 300 wherein the DPH beam-combiner 306, itself, works as a full-reflection mirror. Laser diodes 302a through 302f are located between a mirror 304 and the DPH beam-combiner 306, which works as a full-reflection mirror that is intercoupled with laser diodes 302a through 302f. A combined laser-beam 308 of increased brightness exits through the partially reflecting mirror 304 and is collimated by an external optical unit 310, which is composed of lenses 310a and 310b, forming a collimated beam 312. All components besides the external optical unit are implemented on a planar waveguide 314, which, in turn, is supported by a substrate (not shown in FIG. 3).

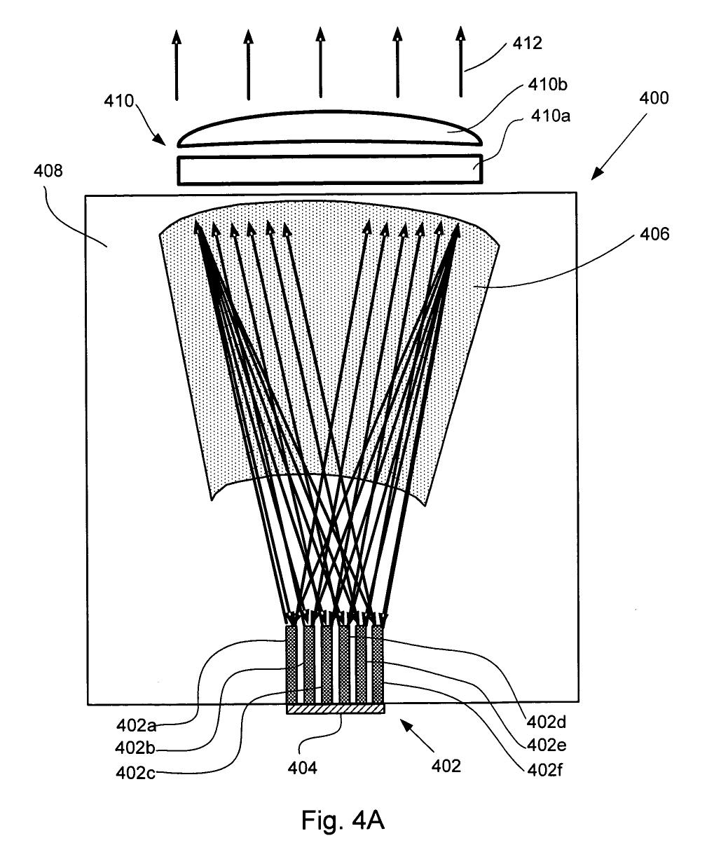

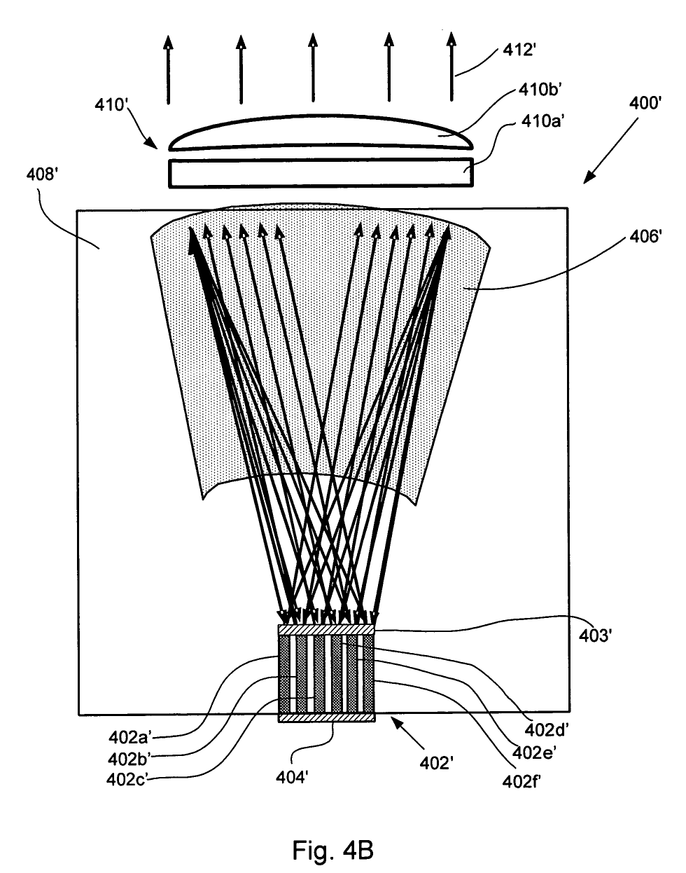

Shown in FIG. 4A is a modification to the beam-combining system 400, which is similar in structure to the system 300 shown in FIG. 3. The DPH beam combiner 406 intercouples all laser diodes 402a through 402f and functions as a partially reflecting mirror, while a mirror 404 is a full-reflection component of the resonator. Laser diodes 402a through 402f and the DPH beam combiner 406, which also functions as a supergrating, are implemented as integrated optic components on a common planar waveguide 408. A focusing optical unit 410 composed of lenses 410a and 410b are external to the planar waveguide 408. Reference numeral 412 designates a collimated output beam of an improved brightness.

In the modification of a beam-combining system 400 shown in FIG. 4B, the DPH beam combiner 406′ intercouples all laser diodes 402a′through 402f′ and functions as an addition to a partially reflecting mirror 403′, while a mirror 404′ is a full-reflection component of the resonator. Laser diodes 402a′through 402f′ and the DPH beam combiner 406′, which also functions as a supergrating, are implemented as integrated optic components on a common planar waveguide 408′. A focusing optical unit 410′ composed of lenses 410a′ and 410b′ are external to the planar waveguide 408′. Reference numeral 412′ designates a collimated output beam of an improved brightness.

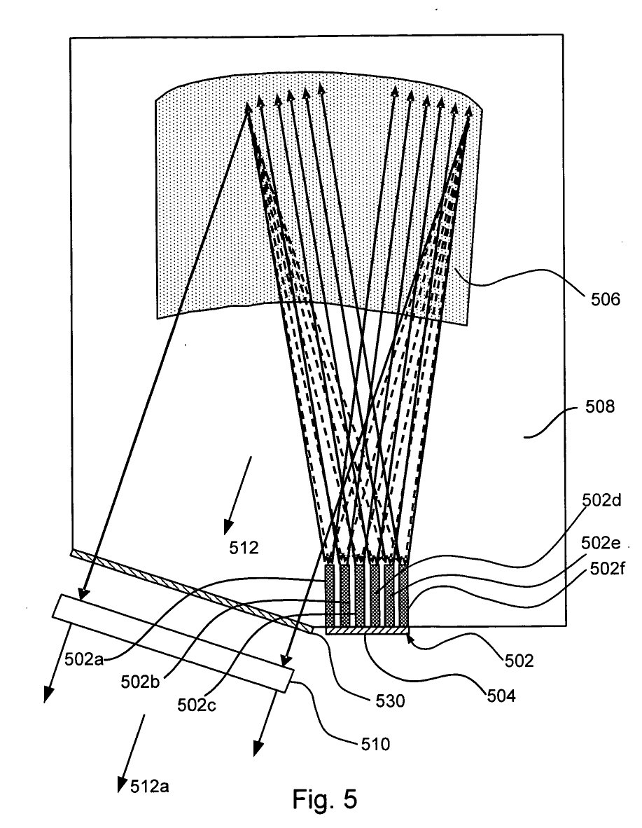

FIG. 5 demonstrates one more implementation of the beam-combining system 500. Laser diodes 502a through 502f have a common full-reflection mirror 504 on their back facets. A DPH beam combiner 506 intercouples all laser diodes 502a through 502f and reflects a part of laser radiation at some angle to the beams that interact with the full-reflection mirror 504. The DPH beam combiner collimates a powerful output beam 512 to decrease laser radiation load on the output facet of the planar waveguide 508 in order to prevent its damage. The output beam 512 passes through a partially transparent mirror 530. Still the output beam 512 will need collimation in the normal-to-planar direction, which is provided by a cylindrical lens 510 that produces a collimated beam 512a.

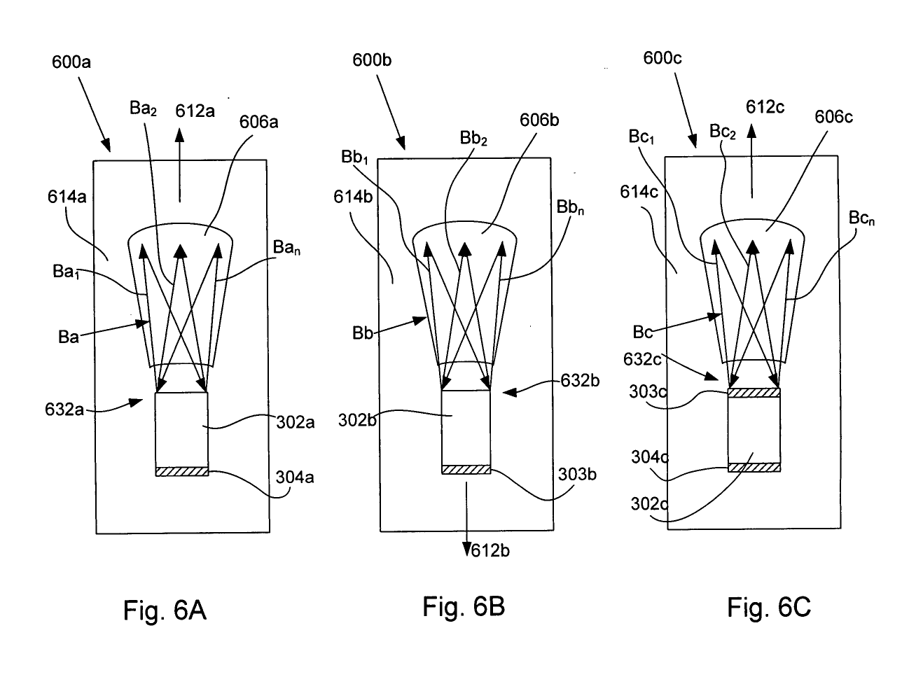

All configurations shown in FIGS. 3 to 5 can be applied to one laser with a wide active area that generates a broad multimode output beam of high divergence. Various modifications of such a system are shown in FIGS. 6A, 6B, and 6C. FIG. 6A illustrates a beam-combining system 600a that is similar to the system 400 shown in FIG. 4A and differs from it in that the system uses a single laser 302a with a wide active area and a broad multimode beam Ba composed of component beams Ba₁, Ba₂ . . . Baₙ of a resonator 632a. The system also incorporates a DHP beam-combiner 606a formed in a waveguide 614a on the output side of the system and a full-reflection mirror 304a on the side of the system opposite the DHP beam-combiner 606a. The output beam is designated by reference numeral 612a. In this modification, the DPH beam-combiner 606a, in addition to the function of a resonator, also functions as a partially reflecting mirror.

FIG. 6B illustrates a beam-combining system 600b that is similar to the system 400 shown in FIG. 3 and differs from it in that the system uses a single laser 302b that has a wide active area and a broad multimode beam Bb composed of component beams Bb₁, Bb₂ . . . Bbₙ of a resonator 632b. The system also incorporates a DHP beam-combiner 606a formed in a waveguide 614b and a partially reflecting mirror 303b on the output side of the system opposite the DHP beam combiner 606b. An output beam is designated by reference numeral 612b. In this modification, the DPH beam-combiner 606b, in addition to the function of a resonator, also functions as a full-reflection mirror.

FIG. 6C illustrates a beam-combining system 600c that is similar to the system 400′ shown in FIG. 4B and differs from it in that the system uses a single laser 302c that has a wide active area and a broad multimode beam Bc composed of component beams Bc₁, Bc₂ . . . Bcₙ of a resonator 632c. The system also incorporates a DHP beam-combiner 606c formed in a waveguide 614c, a partially reflecting mirror 303b, and a fully reflecting mirror 302c. An output beam is designated by reference numeral 612a. In this modification, the DPH beam-combiner 606b, in addition to the function of a resonator, also functions as an additional component to a partially reflecting mirror 303c.

Strictly speaking, in all modifications shown in FIGS. 6A, 6B, and 6C, the respective DPH components 614a, 614b, and 614c are mode selectors rather than beam combiners. However, these components can be also considered equivalent to coherent beam combiners for sub-beams or component beams radiated by narrow stripes of laser-active medium, which satisfies conditions of single-mode generation provided that the surrounded volume of active medium has been removed. A simple way to illustrate this statement is to imagine moving single-mode lasers of the type shown in FIGS. 3 to 5 to one another until the gaps between them disappear and the active medium becomes a single wide strip. In FIGS. 6A, 6B, and 6C, system component beams are designated by symbols Bₐ, B_{b}, and B_{c}, respectively.

All conditions and considerations described above for a plurality of single-mode lasers apply in this invention, resulting in synchronizing all component beams and generating respective single-mode output beams 612a, 612b, and 612c of increased brightness and decreased divergence.

Thus, it has been shown that this invention provides a method and an optical device for combining laser beams on the principle of digital planar holography. The method and apparatus of the invention improve brightness of an output beam by correlating phases and improving fusion of coherent beams emitted from a plurality of laser diodes by means of digital planar holography (DPH). The invention applies to optical chips of a hybrid or monolithic configuration; the former can be realized by fabricating a DPH beam combiner on a separate chip, which is optically coupled to a laser diode array, while the latter presumes embedding the beam combiner into the same planar optical waveguide wherein the laser array is located.

Although the invention has been shown and described with reference to specific embodiments, these embodiments should not be construed as limiting the areas of application of the invention and that any changes and modifications are possible provided that these changes and modifications do not depart from the scope of the attached patent claims. For example, the system may not contain mirrors at all but instead may contain two DPH beam combiners functioning as the respective mirrors. Replacement of all mirrors with the DPH beam combiners of this invention applies to all combinations of the system components described above.

1. A digital optical planar holography system comprising an optical waveguide; at least one laser diode that radiates light of a predetermined wavelength and that comprises a laser-active medium and at least a first mirror; and at least one DPH beam combiner formed in the optical waveguide, said at least one laser diode being optically coupled and optically interacting with said at least one DPH beam combiner and forming in combination therewith an optical resonator.

2. The digital optical planar holography system of claim 1, wherein said at least one DPH beam combiner comprises at least one subgrating formed in the optical waveguide.

3. The digital optical planar holography system of claim 1, wherein said first mirror comprises a full-reflection mirror and wherein the DPH beam combiner comprises a partially reflecting mirror.

4. The digital optical planar holography system of claim 1, wherein said first mirror comprises a partially reflecting mirror and wherein the DPH beam combiner comprises a full-reflection mirror.

5. The digital optical planar holography system of claim 1, comprising N laser diodes, wherein said at least one DPH beam combiner comprises m subgratings, and wherein N and m satisfy the following condition: m=0.5N(N+1).

6. The digital optical planar holography system of claim 1, wherein said at least one subgrating functions as a supergrating.

7. The digital optical planar holography system of claim 6, wherein said first mirror comprises a full-reflection mirror and wherein the DPH beam combiner is used as a partially reflecting mirror.

8. The digital optical planar holography system of claim 7, wherein the DPH beam combiner reflects a part of laser radiation at some angle to the beams that interact with the full-reflection mirror.

9. The digital optical planar holography system of claim 6, wherein said first mirror comprises a partially reflecting mirror and wherein the DPH beam combiner is used as a full-reflection mirror.

10. The digital optical planar holography system of claim 5, wherein the sum of the subgratings forms a supergrating and wherein any number of laser diodes from N laser diodes may simultaneously be optically coupled with and interact with any number of subgratings from m subgratings.

11. The digital optical planar holography system of claim 1, wherein said at least one DPH beam combiner comprises a plurality of standard binary features, each of said binary features being defined by three dimensions that are shorter than said predetermined wavelength.

12. The digital optical planar holography system of claim 11, wherein each of said standard binary features is a rectangular groove with a predetermined length, width, and depth.

13. The digital optical planar holography system of claim 1, further comprising a second mirror.

14. The digital optical planar holography system of claim 13, wherein the first mirror is a full-reflection mirror and the second mirror is a partially reflecting mirror.

15. The digital optical planar holography system of claim 9, wherein said at least one DPH beam combiner comprises a plurality of standard binary features, each of said binary features being defined by three dimensions that are shorter than said predetermined wavelength.

16. The digital optical planar holography system of claim 15, wherein each of said standard binary features is a rectangular groove with a predetermined length, width, and depth.

17. The digital optical planar holography system of claim 1, further comprising a second mirror.

18. The digital optical planar holography system of claim 17, wherein the first mirror is a full-reflection mirror and the second mirror is a partially reflecting mirror.

19. The digital optical planar holography system of claim 17, wherein the digital planar holography beam combiner comprises an additional component to a partially reflecting mirror.

20. A method for improving brightness of a coherent output light beam emitted from the output of a system comprising: one laser diode that has a resonator, a wide active area, and a broad multimode beam composed of component beams of a resonator; at least one optical mirror; an optical waveguide; and a digital planar holography beam combiner formed in the optical waveguide, the method comprising the following steps:
imparting to the digital planar holography beam combiner the function of phase correlation and beam fusion of component beams; and
using the digital planar holography beam combiner as said at least one mirror; and
improving brightness of the coherent beam emitted from the system by correlating the phase of the component beams and fusing the component beams on the way to the output of the system.

21. The method of claim 20, wherein said at least one mirror is a full-reflection mirror.

22. The method of claim 20 wherein said at least one mirror is a partially reflecting mirror.

23. A method of improving brightness of a coherent output light beam emitted from the output of a system comprising laser diodes that emit light beams, each laser diode having a first optical mirror and a second optical mirror; an optical waveguide; and a digital planar holography beam combiner formed in the optical waveguide, the method comprising the following steps:
providing the digital planar holography beam combiner in the optical waveguide as a plurality of subgratings;
imparting to each subgrating a specific function;
coupling selected laser diodes with selected subgratings for optical interaction and for acquiring functions inherent in the selected subgratings;
imparting to the digital planar holography beam combiner the function of a phase correlation, thus forming a coherent beam;
using the digital planar holography beam combiner at least as said first mirror; and
improving brightness of the beam emitted from the system by correlating the phase of the optical beam and fusing the beams on their way to the output of the system.

24. The method of claim 23, comprising the step of using said at least first mirror as a mirror selected from a full-reflection mirror or a partially reflecting mirror.

25. The method of claim 22, wherein one of said first mirror and the second mirror is used as a full-reflection mirror and the other as a partially reflecting mirror.

26. The method of claim 24, wherein the digital planar holography beam combiner comprises an additional component to a partially reflecting mirror.
